(19) United States
(12) Patent Application Publication
(10) Pub. No.: US 2009/0101172 A1
(43) Pub. Date: Apr. 23, 2009

(54) SYSTEM AND AUTOMATIC METHOD FOR EXTRACTION OF GASEOUS ATMOSPHERIC CONTAMINANTS WITH TOXIC PROPERTIES, WHICH ARE RETAINED IN POLYURETHANE FOAM (PUF) FILTERS

(76) Inventors: Francisco Cereceda Balic, Quilpue (CL); Gabriel Cereceda Balic, Quilpue (CL); Mario Dorochesi Fernandois, Vina del mar (CL)

Correspondence Address: ERIC HANSCOM, 7395 PORTAGE WAY, CARLSBAD, CA, 92011, US

(21) Appl. No.: 12/293,123

(22) PCT Filed: Mar. 15, 2007
(86) PCT No.: PCT/ES2007/070055

§ 371 Date: Sep. 16, 2008

(30) Foreign Application Priority Data
Mar. 16, 2006 (CL) 588-2006

(51) Int. Cl. B01D 11/02; B08B 3/08; G05D 23/00

(52) U.S. Cl. 134/16; 422/267; 422/119; 422/109

(57) ABSTRACT

The present invention provides a system and method for automatic extraction of gaseous atmospheric contaminants (for example HAPs and PCBs) with toxic properties, which are retained in polyurethane foam filters (PUF) that consists of:
An automatic extraction device, which allows extracting chemicals compounds of interest using a sequence of organic solvents where the PUF must be immersed in, by means of a process of extraction based on compression and decompression cycles of the PUF; and
A drying device which permits to dry the cleaned PUF, from the previous process, by means of sweeping the solvent with hot gaseous ultra pure N₂, eliminating the solvent until achieving the dryness of the PUF.

### FIELD OF THE INVENTION

The invention relates to a system and method of extraction of organic chemical compounds with toxic properties from polyurethane foam filters (PUF) in which they are retained, wherein the analytes of interest are gaseous atmospheric contaminants present in the ambient air. More specifically, it is described how to extract those chemical compounds from the filters in a mechanical and automatic manner, as a way to increase the quality of this analytical procedure.

### BACKGROUND OF THE INVENTION

At present time, there are not equipments in the market with these characteristics, and the procedures recommended in the literature or by the international environmental agencies are approached using classic methods and equipments, those usually used in analytical chemistry to extract analytes from materials and/or solid matrices such as PUF, using Soxhlet equipment (e.g. method EPA-3540). These equipments use large amount of solvents (measured in liters), long times of extraction (12 hours or days) and high energy expenses. Furthermore, they are not automatized, needing the presence of an operator for security reasons. The other existing alternative is to do the same extraction procedure in a manual form, which also implies the presence of an operator and the realization of repetitive mechanical movement that can lead to work related health problems (tendonitis). All the procedures previously described have low levels of efficiency, reproducibility and repetitiveness, and they also have low efficiency of extraction of the contaminants of interest.

In the document of de R. Niehaus, B. Scheulen, H. W. Dürbeck. (1990), Sci. Total Environ, 99:163-172. “Determination of airborne polycyclic aromatic hydrocarbons using a filter/adsorbed combination”, it is described a glass apparatus for the extraction of analytes from a PUF, by manual compression and decompression of a PUF immersed in organic solvent. The glass apparatus has a cylindrical form, surrounded by a concentric double sleeve, with a superior and inferior opening for hot water circulation inside the sleeve as a manner to increase the temperature in the cylinder and facilitate the extraction of analytes from the PUF. The investigation compares the efficiency of the traditional procedure with this new concept of extraction with solvent, using manual compression and decompression of a PUF. The work does not mention the automatization of any step of the process, or the optimization of the extraction procedure considering frequency of compression and decompression, extraction program (intervals between pressure application and pauses and total time of extraction), reproducibility, repetitiveness, quantity and sequence of solvents, and also the consideration of using solvent sweeping, among others.

As a consequence, it is necessary to automatize the extraction procedure, to allow the reduction of solvent volume to milliliters, the time to minutes and to obtain superior extraction efficiencies, and notably improving the reproducibility and security of operation, all factors that also lead to an important reduction of costs

### SUMMARY OF THE INVENTION

The objective of this work is to develop a system of extraction of organic chemical compounds with toxic properties, such as Polycyclic Aromatic Hydrocarbons (PAHs) and Polychlorinated Biphenyls (PCBs), contaminants present in gaseous atmospheric samples (ambient air). The air samples are made up of a solid phase mixture consisting of particulate matter (PM), and a gaseous phase. The devices for taking air samples collect the samples on different types of filters, using polyurethane foam filters (PUF) to retain the gaseous phase, which is extracted using organic solvents. The invention is aimed to develop a mechanical and automatic method to extract analytes from those filters, in order to increase the extraction efficiency, and the reproducibility and repetitiveness of the analytical procedure; using a reduced volume of solvents and shorter time of extraction (cost reduction).

The automatic extraction system of gaseous atmospheric contaminants (for example PAHs PCBs) retained in PUF, comprises two devices with complementary functions:

The first one is an extraction device, which allows the extraction of chemicals of interest using a sequence of organic solvents where the PUF must be immersed. The process of extraction is based on compression and decompression cycles of the PUF using a mechanical-pneumatic piston, which is assisted by valves and oil-free compressors that are regulated by a PLC, which permits the automatic programming of the desired sequence to achieve maximum extraction efficiency. The device design takes into account luminous and acoustic security signals to indicate the end of the process, and also filters and eliminators of possible residues that could contaminate the extraction process. This device is useful to prepare the sample material (PUF) for gases present in atmospheric aerosols, to clean the PUF before usage in sampling and after sampling, and also to extract the compounds of interest retained in the filter. The second device, complementary to the previous one, consists of a hermetic container with entrance and exit valves which allow drying the cleaned PUF, from the previous process, by means of solvent sweeping with hot ultra-pure gaseous N₂, eliminating the solvent to obtain a dry PUF. The process of cleaning a drying of the PUF is chromatographically certified and the PUF is stored in a hermetic container to avoid posterior contamination.

None of these equipments can be found in the market today. The original and automatized form of extraction of analytes from those PUF filters allows overcoming many of the typical deficiencies of the traditional systems and is a step forward in the state of the art related to extraction systems for solid samples, and especially for the previously described use.

Therefore, one of the main objectives of the present invention is to provide an automatic extraction system of gaseous atmospheric contaminants (like PAHs and PCBs) with toxic properties, from polyurethane foam filters (PUF) that comprises:
An automatic extraction device, which permits the extraction of chemicals compounds of interest, using a sequence of organic solvents where the PUF must be immersed, by means of a extraction process based in compression and decompression cycles of the PUF; and
A drying device which permits to dry the cleaned PUFs, from the previous process, by means of sweeping the solvent with hot ultra-pure gaseous N₂, eliminating the solvent until the PUF is dry.

Wherein, the automatic extraction device comprises:
A mechanic-pneumatic piston;
A control unit for solenoid valves, which allow controlling the piston movement;
A metallic support; and
A glass container for PUF extraction fastened to such metallic support.

The mechanic-pneumatic piston permits to carry out the procedure of compression and decompression, this is accomplished by compression of ambient air using an oil-free pressure pump with Teflon membrane, which sends the compressed air through rapid connection tubes of the entrance valve in the piston; the lubrication of the piston is accomplished with a minuscule layer of oil formed on the piston rod, which comes from an oil deposit that allows the formation of an air aerosol containing very small oil particles in suspension. Two measures have been implemented to avoid any possible contamination from the oil of the system: the first one lies in the Teflon fastener located at the inferior end of the piston rod, which has a small sealed conicity in its superior piece, thus the conicity traps any possible drop from the layer of oil that might fall from the piston rod and avoids the contamination of the inferior end of the Teflon fastener; besides, the two parts that form the Teflon fastener are independent, consequently the contamination avoidance by this route is guaranteed, preventing the accidental contamination of rod of the glass compression blade that works over the PUFs; and the second measure is an oil trap located at the end of the tube that connects the rapid connection of the exit valve for compressed air of the piston with the trap; this washable and takedown trap is connected to an exit to eliminate the residual compressed air from the system to the exterior in a definitive manner; furthermore, the pneumatic piston has a regulation screw at the entrance and exit of the compressed air, those screws can mechanically regulate the movement of the piston rod and thus, fit the glass container for PUF extraction to different types of PUF (different sizes and densities), to different extraction solvents volumes, and different extraction procedures as well; this regulation can also control the magnitude of pressure applied to the PUF during the compression and expansion steps with the purpose of improving the efficiency of extraction; the mechanical-pneumatic piston uses compressed air to work, hence an exit tube transports the pressurized air to the piston entering through the valve, the return air exits through the valve and is leaded by a tube to the entrance in the control unit; to lubricate the piston, a device mixes the air, which has been compressed by the oil-free pressure pump with Teflon membrane, with a small amount of oil, the air thus prepared is transported to an solenoid valve, which is connected to an exit tube directed to the piston, the residual air that is discarded once has passed through the piston, exits the control unit through a tube and reaches the oil trap.

The control unit controls numerous solenoid valves, which permit to perform the movement of the piston by means of a PLC, this digital microprocessor has a LCD screen and allows the programming of different PUF extraction procedures by means of increasing the compression, based in a higher or lower pressure of the piston controlling the amount of air being compressed, furthermore the control unit has a series of electronic elements such as differentials, acoustic and luminous alarms that indicate the ending of an operation sequence and thus they permit to determine the time intervals for pressure versus pauses, and the total time of extraction; it allows the use PUFs with different thickness and/or densities; it allows additionally compressing the PUF to leave it as free as possible of extraction solvents, among others.

The metallic support consists of a cylindrical duraluminium support screwed to an iron base inserted in a plastic platform, which allows fixing the mechanical-pneumatic piston to the cylindrical fastener of the extraction system; the cylinder has in its upper part a fastener screw, which allows the regulation of the height at which the fastener support of the mechanical-pneumatic piston will be placed; the mechanical-pneumatic piston is screwed and secured to the cylindrical support on a small sheet metal, regulation screws allow controlling the movement of the piston rod; plastic circular clamps support the glass container for PUF extraction, from its upper and also from its lower part; the plastic circular clamps have two parts, one that surrounds the cylinder, with a winged thread bolt for fastening and security and a second part that surrounds the glass container for PUF extraction.

The glass container for PUF extraction is built of borosilicate glass and has a mouth that permits the insertion of the PUF in the extraction system; this mouth is a ground glass conical female which fits an upper part consisting in a ground glass conical male that allows the hermetic closure of the extraction container to avoid solvent spills during the extraction; also and to avoid overpressures produced by the evaporated solvent during the process of compression and expansion of the PUF, the upper part is provided with a Teflon valve that can be opened at will during the process; furthermore, to introduce new portions of solvent or to change the extraction solvent, the same upper part is provided with a ground conical female, which has a ground conical male glass lid that allows the hermetic closure of the extraction container anew, once such solvent has been introduced; a glass male mouth with exterior thread permits joining the Teflon piece that works as guide for the rod of the compression blade so it can be inserted and moved in the right form and vertically inside the body of the glass container for PUF extraction; once the PUF has been extracted, the extraction solvent must be removed from the extraction container, for that purpose it is provided a Teflon valve joined to a ground glass conical male that allows a direct connection to the extraction container, thus when the Teflon valve is opened, the liquid is poured directly into a distillation round bottom flask that has a mouth compatible with the ground conical glass male, this glass male has an open hose connector, which permits to even up the pressures during the elimination of the extraction solvent from the extraction container, facilitating the flow of liquid to the distillation flask.

The drying device consists in a container for drying the PUF and a line to supply hot ultra-pure nitrogen (N₂).

The drying device for the PUF comprises a lid that has an upper part with a wedge for coupling with the lower part and it has a groove where it can be placed a silicone o-ring. This o-ring is useful to hold tight and hermetic a transparent glass that is adjusted in the wedge between the upper and lower part of the lid and it is used as a window to observe the drying process; the lower part also has a groove to place a silicone o-ring similar to the previous one in form and function; in the center of the glass window there is a metallic male with an interior and exterior sweglook thread for connection to the hot N₂ line by means of a sweglook nut, which allows the entrance of the N₂ to the drying container for the PUF; this N₂ entrance connection is hermetically sealed against the glass by means of a lock nut that has an exterior thread which permits to screw it to the metallic male, furthermore both pieces are sealed against the glass using o-rings with appropriate diameters; for the drying procedure, the PUFs are placed on a PUF support located inside the lower part of the drying container for the PUF, or body of the container; the lid and the body of the container are coupled by means of metallic fasteners, which can be adjusted to achieve maximum tightness, and consequently obtain an hermetic sealing of the drying container for the PUF.

The line of hot ultra-pure nitrogen (N₂) supply consists of a N₂ cylinder with a predetermined pressure, which is reduced using a secondary manometer at 400 kPa (4 bars), a pipe with N₂ at 400 kPa (4 bars) reaches an extraction hood and connected to it by means of a needle valve for coarse flow regulation, which is at the same time connected to a needle valve for fine flow regulation; the line for hot nitrogen N₂ supply is at the same time connected and regulated by the valve, the thermal regulation (9) of this line is achieved thanks to a blanket provided with electric resistances regulated and controlled by a thermostat, which keeps the temperature of this line at approximately 70° C.; in this manner the drying of the PUF is accomplished by means of removing the residual solvent retained in the PUF using a process of sweeping with N₂, the heating of the N₂ helps to evaporate the solvent and as a consequence notably reduces the drying time, and the N₂ that has passed through the PUF is eliminated by a regulation valve through a hose to the interior of the extraction hood.

The PUF support consists of a first support for the PUF of a first diameter which rests on a metallic grid with perforations of 1 cm; the first support is supported by cylindrical legs that separate it from the second support which has the same dimensions of the first one, but used for PUFs with a second diameter, smaller than the first diameter; this second support is also rested on some cylindrical legs to separate it from the bottom of the drying container for the PUF.

The other main objective of this invention is to provide an automatic method of extraction of gaseous atmospheric contaminants (for example PAHs and PCBs) with toxic properties, from polyurethane foam filters (PUF) where they are retained, that is composed of the following steps:
Extract the chemical compounds of interest, using a sequence of organic solvents where the PUF must be immersed, by means of extraction process based in compression and decompression cycles of the PUF;
Dry the cleaned PUFs, from the previous step, by means of sweeping of the solvent with hot gaseous ultra-pure N₂, eliminating the solvent until accomplish the drying of the PUF; and
Chromatographically certify the cleanliness of the PUF.

The chemical compounds extraction step using a sequence of organic solvents where the PUF must be immersed, by means of an extraction process based in compression and decompression cycles of the PUF; it is accomplished by means of a mechanical-pneumatic piston; a control unit for solenoid valves, which allow controlling the piston movement; a metallic support; and a glass container for PUF extraction fastened to such metallic support. Such mechanical-pneumatic piston permits to carry out the compression and decompression procedure, this is accomplished by compression of ambient air using an oil-free pressure pump with Teflon membrane, which sends the compressed air through tubes to the rapid connection of the entrance valve in the piston; the lubrication of the piston is accomplished with a minuscule layer of oil formed on the piston rod, which comes from an oil deposit that allows the formation of an air aerosol containing very small oil particles in suspension. Two measures have been implemented to avoid any possible contamination from the oil that works over the PUFs; and the second measure is an oil trap located at the end of the tube that connects the rapid connection of the exit valve for compressed air of the piston with the trap; this washable and takedown trap is connected to an exit to eliminate the residual compressed air from the system to the exterior in a definitive manner; furthermore, the pneumatic piston has a regulation screw at the entrance and exit of the compressed air, those screws can mechanically regulate the movement of the piston rod and thus, fit the glass container for PUF extraction to different types of PUF (different sizes and densities), to different extraction solvents volumes, and different extraction procedures as well; this regulation can also control the magnitude of pressure applied to the PUF during the compression and expansion steps with the purpose of improving the efficiency of extraction; the mechanical-pneumatic piston uses compressed air to work, hence an exit tube transports the pressurized air to the piston entering through the valve, the return air exits through the valve and is leaded by a tube to the entrance in the control unit; to lubricate the piston, a device mixes the air, which has been compressed by the oil-free pressure pump with Teflon membrane, with a small amount of oil, the air thus prepared is transported to an solenoid valve, which is connected to an exit tube directed to the piston, the residual air that is discarded once has passed through the piston, exits the control unit through a tube and reaches the oil trap.

The control unit controls numerous solenoid valves, which permit to perform the movement of the piston by means of a PLC, this digital microprocessor has a LCD screen and allows programming of different forms of PUF extraction by means of increasing the compression, based in a higher or lower pressure of the piston controlling the amount of compressed air, furthermore the control unit has a series of electronic elements such as differentials, acoustic and luminous alarms that indicate the ending of an operation sequence and as a result they permit to determine the pressure time intervals versus pauses, and the extraction total time; it allows the use PUFs with different thickness and/or densities; it allows the compression of the PUF to leave it as free as possible of extraction solvents, among others.

The metallic support consists of a cylindrical duraluminium support screwed to an iron base inserted in a plastic platform, which allows fixing the mechanical-pneumatic piston to the cylindrical fastener of the extraction system; the cylinder has in its upper part a fastener screw, which allows the regulation of the height at which the fastener support of the mechanical-pneumatic piston will be placed; the mechanical-pneumatic piston is screwed and secured to the cylindrical support on a small sheet metal, regulation screws allow to control the movement of the piston rod; plastic circular clamps support the glass container for PUF extraction, from its upper and also its lower part; the plastic circular clamps have two parts, one that surrounds the cylinder, with a winged thread bolt for fastening and security and a second part that surrounds the glass container for PUF extraction.

The glass container for PUF extraction is built of borosilicate glass and has a mouth that permits the insertion of the PUF in the extraction system; this mouth is a ground glass conical female which fits an upper part consisting in a ground glass conical male that allows the hermetic closure of the extraction container to avoid solvent spills during the extraction; also and to avoid overpressures produced by the evaporated solvent during the process of compression and expansion of the PUF, the upper part is provided with a Teflon valve that can be opened at will during the process; furthermore, to introduce new portions of solvent or to change the extraction solvent, the same upper part is provided with a ground conical female, which has a ground conical male glass lid that allows the hermetic closure of the extraction container anew, once such solvent has been introduced; a glass male mouth with exterior thread permits joining the Teflon piece that works as guide for the rod of the compression blade so it can be inserted and moved in the right form and vertically inside the body of the glass container for PUF extraction; once the PUF has been extracted, the extraction solvent must be removed from the extraction container, for that purpose it is provided a Teflon valve joined to a ground glass conical male that allows a direct connection to the extraction container, thus when the Teflon valve is opened, the liquid is poured directly into a distillation round bottom flask that has a mouth compatible with the ground conical glass male, this glass male has an open hose, which permits to even up the pressures during the elimination of the extraction solvent from the extraction container, facilitating the flow of liquid to the distillation flask.

The step for drying the cleaned PUF, by means of solvent sweeping with hot gaseous ultra-pure N₂, eliminating the solvent until the PUF is dry; it is accomplished with the use of a drying container for the PUF; and a line for hot gaseous ultra-pure nitrogen (N₂) supply.

The drying container for the PUF comprises a lid that has an upper part with a wedge for coupling with the lower part and it has a groove to accommodate a silicone o-ring. This o-ring is useful to hold tight and hermetic a transparent glass that is adjusted in the wedge between the upper and lower part of the lid and it is used as a window to observe the drying process; the lower part also has a groove to accommodate a silicone o-ring similar to the previous one in form and function; the glass window has on its center a metallic male with an interior and exterior sweglook thread for connection to the hot N₂ line by means of a sweglook nut, which allows the entrance of the N₂ to the drying container for the PUF; this N₂ entrance connection is hermetically sealed against the glass by means of a lock nut that has an exterior thread which allows screwing it to the metallic male, furthermore both pieces are sealed against the glass using o-rings of appropriate diameters; for the drying procedure, the PUFs are placed on a PUF support located inside the lower part of the drying container for the PUF, or body of the container; the lid and the body of the container are coupled by means of metallic fasteners, which can be adjusted to achieve maximum tightness, and consequently to obtain an hermetic sealing of the drying container for the PUF.

The line of hot ultra-pure nitrogen (N₂) supply consists of a N₂ cylinder with a predetermined pressure, which is reduced using a secondary manometer at 400 kPa (4 bars), a pipe with N₂ at 400 kPa (4 bars) reaches an extraction hood and connects to it by means of a needle valve for coarse flow regulation, which is at the same time connected to a needle valve for fine flow regulation; the line for hot nitrogen N₂ supply is at the same time connected and regulated by the valve, the thermal regulation of this line is achieved thanks to a blanket provided with electric resistances regulated and controlled by a thermostat, which keeps the temperature of this line at approximately 70° C.; in this manner the drying of the PUF is accomplished by means of removing residual solvent retained in the PUF using a process of sweeping with N₂, the heating of the N₂ helps to evaporate the solvent and as a consequence notably reduces the drying time, and the N₂ that has passed through the PUF is eliminated by a regulation valve through a hose to the interior of the extraction hood.

The PUF support consists of a first support for the PUF of a first diameter which rests on a metallic grid with perforations of 1 cm; the first support is supported by cylindrical legs that separate it from the second support which has the same dimensions of the first one, for the PUFs with a second diameter, smaller than the first diameter; this second support is also rested on some cylindrical legs to separate it from the bottom of the drying container for the PUF.

Once the PUF has been cleaned and dried, it is necessary to store it so it does not get contaminated before it reaches the sampling location.

The automatic extraction equipment can be used for the extraction of PUFs which come from an ambient air sampling event, as well as to clean a PUF from residual contaminants originated from the manufacture process before its use in field sampling, and also as a form to guarantee that the PUF is clean at the time of taking the atmospheric sample.

### BRIEF DESCRIPTION OF THE DRAWINGS

FIG. 1A shows a schematic diagram of the automatic extraction system for gaseous atmospheric samples.

FIG. 1B shows the automatic extraction system for atmospheric samples of the invention.

FIG. 2 shows the fastener system for the glass rod of the compression blade of the automatic extraction system of the invention.

FIG. 3 shows the duraluminium support that allows the attachment of the mechanical-pneumatic piston to the cylindrical fastener of the extraction system of the invention.

FIGS. 4A and 4B show the fastener system of the arm and the support for the pneumatic piston of the extraction system of the invention.

FIGS. 5A and 5B show the clamp that holds the glass body of the extraction system of the invention, its lower and upper view respectively.

FIG. 6 shows a three-dimensional view of the automatic extraction system for gaseous atmospheric samples of the invention.

FIG. 7 shows a complete three-dimensional view of the glass body of the automatic extraction system for gaseous atmospheric samples of the invention.

FIG. 8 shows an arrangement of the components of the drying system for the PUF, to be used in the collection of gaseous atmospheric samples of the invention.

FIG. 9 shows the drying system for the PUF assembled with all its components.

FIG. 10 shows a transversal cut of the extraction container for the PUFs.

FIG. 11 shows a scheme of the drying system of the PUF.

FIG. 12 shows a scheme of the component parts of the drying container for the PUF.

FIG. 13 shows a transversal cut of the component parts of the drying container for the PUF.

FIGS. 14A and 14B show the component parts of the PUF support.

FIGS. 15A and 15B show an isometric view of the drying container for the PUF and the same container closed respectively.

### DESCRIPTION OF THE PREFERRED EMBODIMENTS

The automatic extraction system for gaseous atmospheric contaminants (for example PAHs and PCBs) retained on PUF, comprises two devices with complementary functions.

The first one is an extraction device, which allows the extraction of chemicals of interest using a sequence of organic solvents where the PUF must be immersed. This device consists in an automatic extraction system for chemical compounds at trace level, contaminants present in gaseous atmospheric samples (ambient air).

The second device, complementary to the previous one, is a drying device for the PUF, which consists of a hermetic container with entrance and exit valves to allow drying the cleaned PUF, obtained from the previous process, by means of solvent sweeping with hot ultra-pure gaseous N₂, eliminating the solvent until the PUF is dry. The process of cleaning and drying of the PUF is chromatographically certified and the PUF is stored in a hermetic container to avoid posterior contamination.

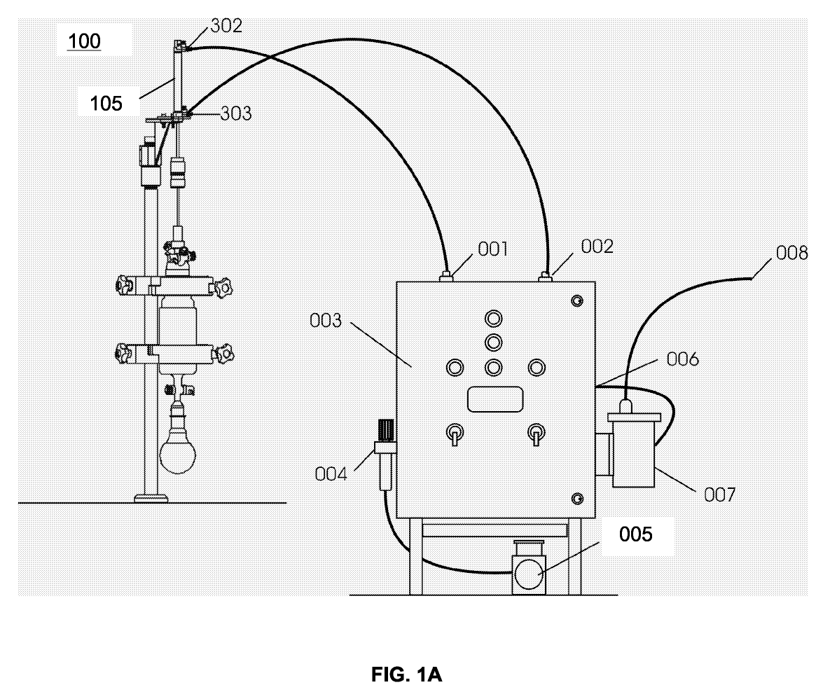

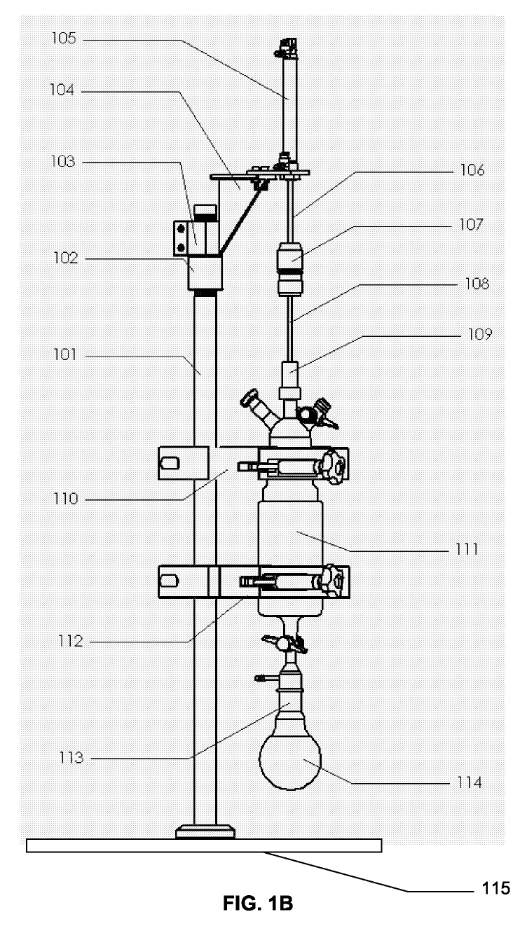

As schematically shown in FIG. 1A, the extraction system (100) is based in the action of a mechanical-pneumatic piston (105) which uses compressed air to work, with that purpose there is an exit tube (001) that drives the pressurized air to a piston (105) entering through an entrance valve (302). The return air comes out from an exit valve (303) and it is directed by means of a tube to the entrance (002) in a control unit (003). To lubricate the piston, the air compressed by an oil-free pressure bomb with Teflon membrane (005) is mixed with a minimal amount of oil in a device (004). The air thus prepared is transported to a solenoid valve (not shown), which is connected to the exit tube (001) in direction to the piston (105). The control unit (003) of the solenoid valves, which allow the movement of the piston with the help of a PLC (not shown), this digital microprocessor has a LCD screen and permits to program different forms of PUF extraction by means of increasing the compression, based on higher or lower piston pressure controlling the amount of air being compressed. Furthermore, the control unit (003) has a series of electronic elements, such as differentials, acoustic and luminous alarms that indicate the ending of an operation sequence, etc. The residual air that is discarded once it has passed through the piston (105), comes out of the control unit (003) through a tube (006) and reaches an oil trap (007). This takedown and washable oil trap (007) is connected to an exit tube (008), as a form to definitively eliminate the residual compressed air from the system to the exterior, by this means avoiding the permanence of contaminated air inside the laboratory where the extraction system for the PUF is being used.

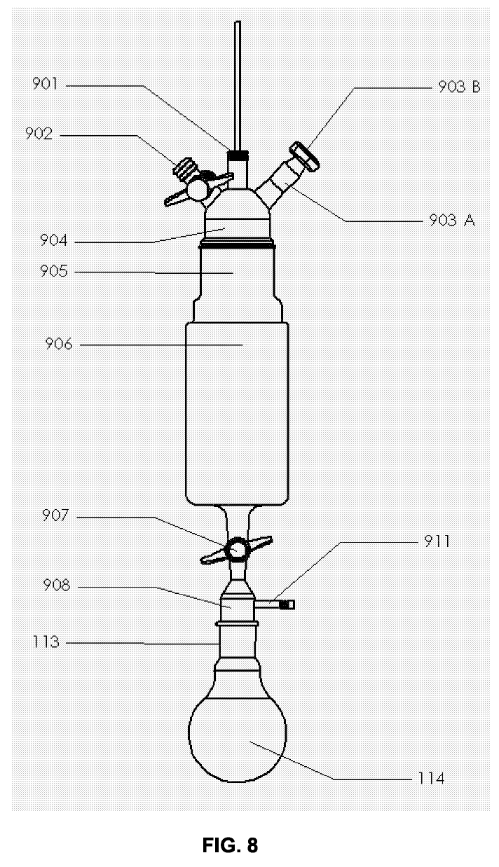

FIG. 1B shows the component parts of the extraction device (100), which is made up of a vertical cylindrical duraluminium support (101) which is screwed to an iron base (115) inserted in a plastic platform (not shown). The cylindrical support (101) has a fastener screw (102) in its upper part, which allows the regulation of the height at which the fastener support (103) of the mechanical-pneumatic piston (105) will be placed. The mechanical-pneumatic piston (105) is screwed and secured to the cylindrical support (101) on a small sheet metal (104), regulation screws (302, 303) allow controlling the movement of the piston (105) rod (106). In the lower part of this rod is located a Teflon fastener (107) that has a mechanism to secure the stem of the compression glass blade (108) which acts over the PUFs as shown later. A glass container for the PUF extraction (111) has a glass male element with thread, in which a Teflon adapter (109) is connected and works as a guide for the proper and vertical entrance of the compression glass blade (108) to the interior of the extraction system (111). The glass container for extraction of the PUF (111) is fastened to the cylindrical duraluminium support (101) by means of two plastic circular clamps (110, 112) which are lined with cork sheets and supplied with winged thread bolts for fastening and security. At one extreme, the extraction container (111) has a the ground conical glass male element (908) (see FIG. 8), NS29/32, which allows to connect a distillation round bottom flask (114) which has ground conical glass female mouth (113), NS29/32 directly to the extraction container.

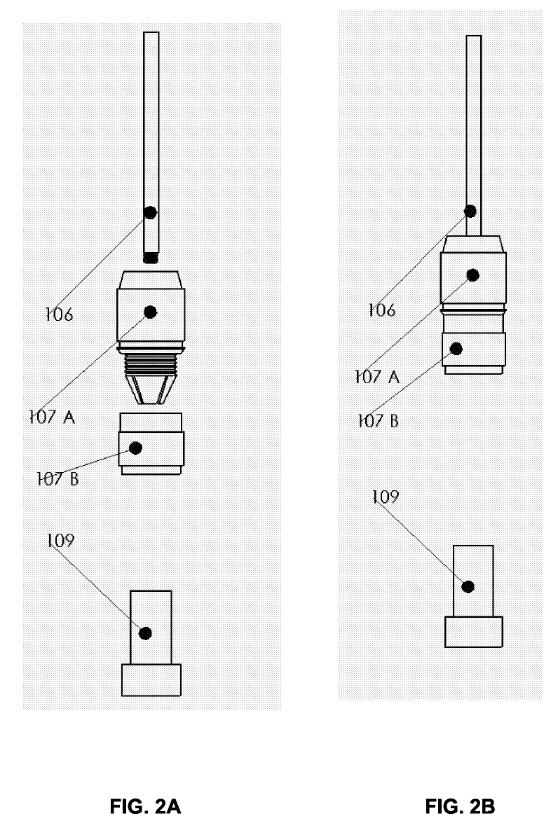

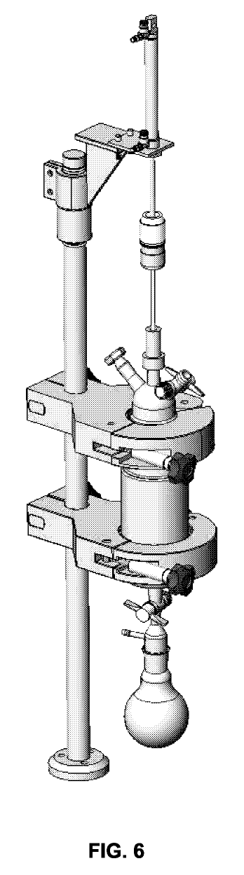

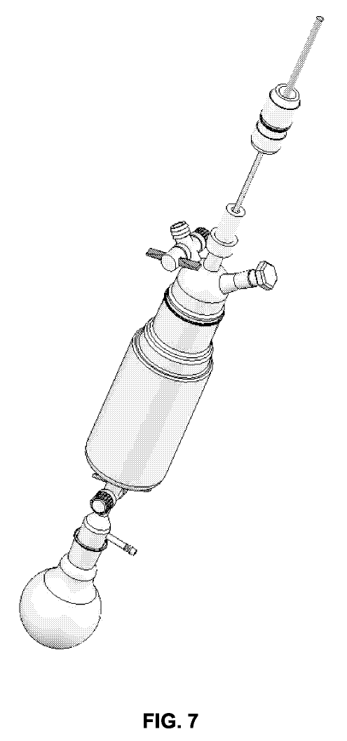

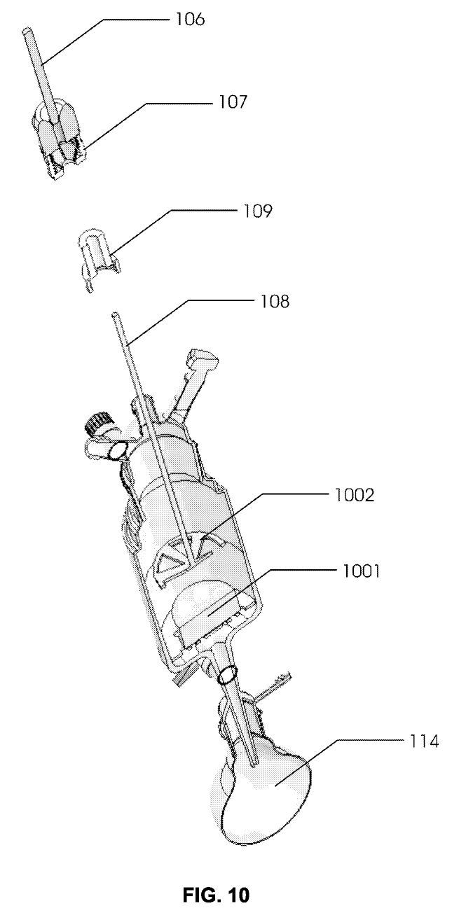

FIGS. 2A and 2B show the detailed Teflon fastener (107). FIG. 2A shows that the Teflon fastener (107) consists of two parts, the upper part (107A) which has a female thread in the upper cylindrical part where the extreme of the piston (105) rod (106) is screwed, and a male thread in the inferior part that ends in a conical extreme with small flexible openings that can be closed when the inferior part (107B) is screwed. This last one has a female thread in the cylindrical part, the rest of the cylinder accommodates the conical extreme of the upper part (107A). By this means, when the two parts are closed, the rod of the glass compression blade (108) (see FIG. 10) is left pressed by the fastener system, preventing it from sliding while the pneumatic piston (105) is performing its mechanical work. The Teflon adapter (109) works as a guide to permit the proper vertical entrance of the rod of the compression blade (108) into the glass container for the PUF extraction (111) (see FIGS. 6, 7, 8 and 10). FIG. 2B shows the closed Teflon fastener (107) and the piston (105) rod (106) connected to the upper part of the Teflon fastener (107).

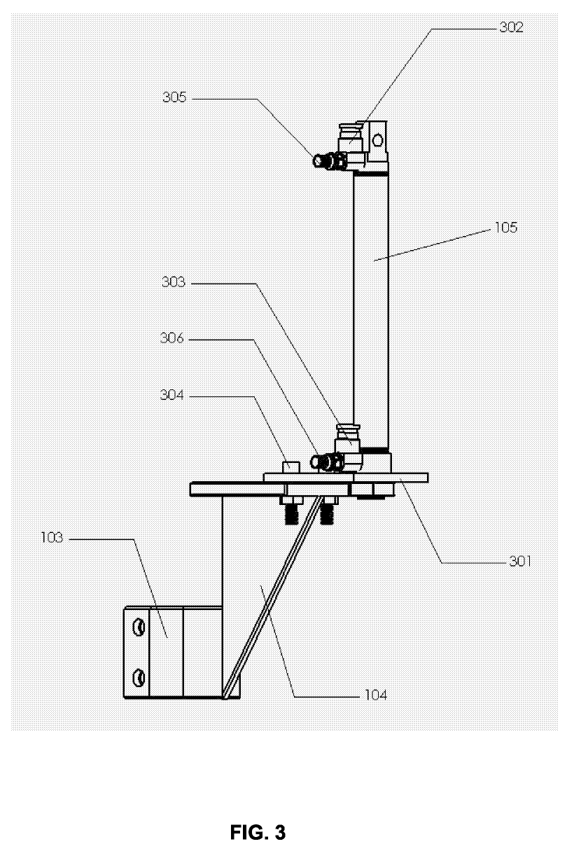

FIG. 3 shows the pneumatic piston (105) in detail. The metallic support (104) sustains an aluminium sheet metal (301) that allows holding the piston (105) by a screw (304). The action of the pneumatic piston (105), allows to carry out the compression and decompression procedure on which the developed extraction method is based, this is achieved by means of compression of ambient air by an oil-free pressure bomb with Teflon membrane (005) which sends this compressed air through 1 cm diameter Tygon tubes (001, 002) to the rapid connection of the entrance valve in the piston (302). The lubrication of the piston is accomplished with a minuscule layer of oil formed on the piston rod, which comes from an oil deposit (004) that allows the formation of an air aerosol containing very small oil particles in suspension; this permits the lubrication of the piston. Two measures have been implemented to avoid any possible contamination with the oil: the first one consists in the Teflon fastener (107) located at the inferior end of the piston (105) rod (106), which has a small sealed conicity in its superior piece (107A), thus the conicity traps any minute drop that might fall from the layer of oil present on the piston (106) rod and avoids the contamination of the inferior end of the Teflon fastener system (107B). Moreover, the two parts that form the Teflon fastener (107) are independent, consequently the contamination avoidance by this route is guaranteed, preventing the accidental contamination of the rod of the glass compression blade (108) that works over the PUFs; and the second measure is an oil trap (007) at the end of the tube (006) that connects the rapid connection of the exit valve of the compressed air (303) of the piston (105) with the trap (007). This washable and takedown oil trap (007) is connected to an exit which can be joined to a tube (008) to definitively eliminate the residual compressed air from the system to the exterior.

All the control system (003) of the solenoid valves (not shown) which permit to perform the movement of the piston is done with the help of a PLC, this digital microprocessor has a LCD screen and allows programming different PUF extraction procedures by means of increasing the compression, based on a higher or lower pressure of the piston controlling the amount of air being compressed. Furthermore, the pneumatic piston has a regulation screw at the entrance (305) and at the exit (306) of the pressurized air, the movement of the piston (106) rod can be mechanically regulated with these screws and in this form the glass container for PUF extraction (111) can be adjusted to different PUF characteristics (different sizes and densities); to different volumes of extraction solvent, and also to different extraction procedures. With this regulation it can also be modified the intensity of the pressure applied to the PUF during the compression and expansion steps, as a form to optimize the extraction efficiency. The control system as a whole, thus allows determining the pressure times versus pauses, and the total extraction time; it allows using PUFs with different thickness and/or density; it allows to additionally compressing the PUF to leave it as free as possible of the extraction solvent, among others. All this set of automatized actions permit, among other things, to significantly increase the possibility of optimizing the extraction procedure, taking into account parameters such as frequency of compression and decompression, program of extraction, reproducibility, repetitiveness, amount and sequence of solvents and solvents polarities, in a systematic and friendly manner.

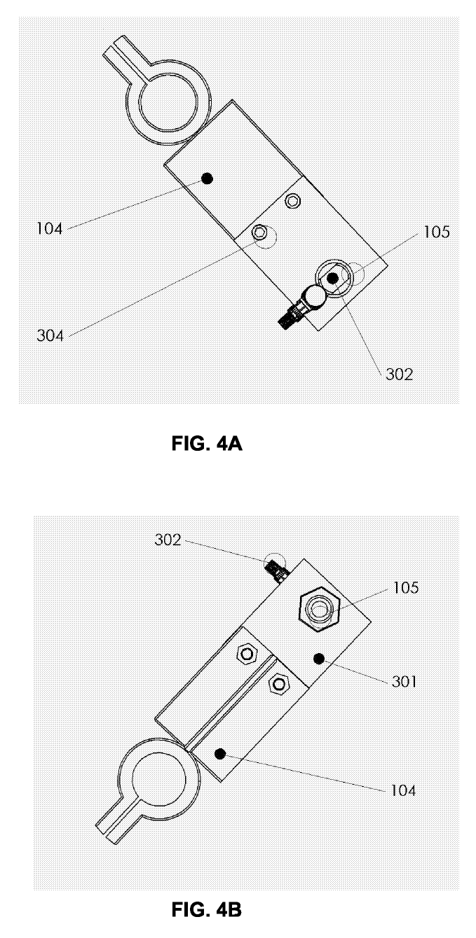

FIG. 4A shows an upper view of the metallic support (104) that allows fixing the mechanical-pneumatic piston (105) to the cylindrical support (101) of the extraction system (100). In that figure can be appreciated the two screws (304), which in a preferred manner are of the Allen type, and they fasten the aluminium sheet metal (301) to the metallic support (104) and the regulation screw (302) of the pneumatic piston (105). FIG. 4B shows a lower view of the metallic support (104) which allows fixing the mechanical-pneumatic piston (105) to the cylindrical support (101) of the extraction system (100) assembled in this manner.

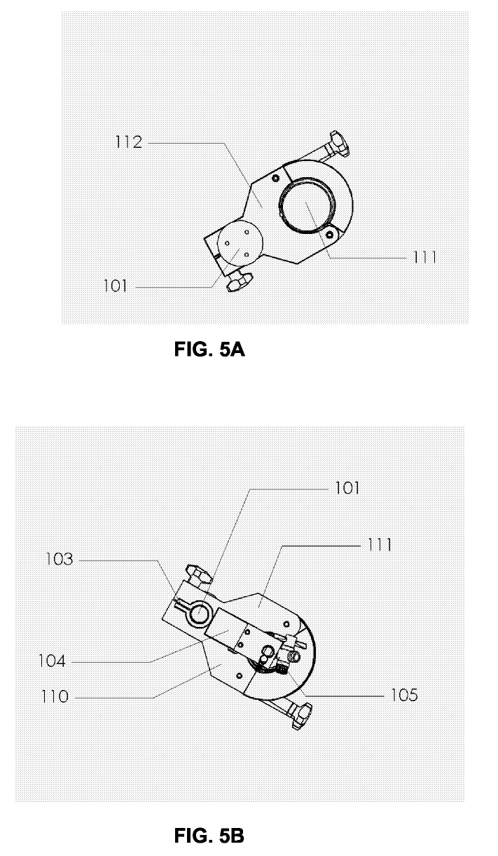

FIG. 5A shows a lower view of the plastic circular clamps (110, 112) that hold the glass container for the PUF extraction (111), by its upper and also its lower part, the plastic circular clamps (110, 112) are composed by two parts, the first one clasps the cylinder (101), with its respective winged thread bolt for fastening and security and the second part clasps the glass container for PUF extraction (111). FIG. 5B shows an upper view of the plastic circular clamps (110, 112) where in addition it can be seen the metallic covering of the first circular clamp which works for fastening to the cylindrical support (101).

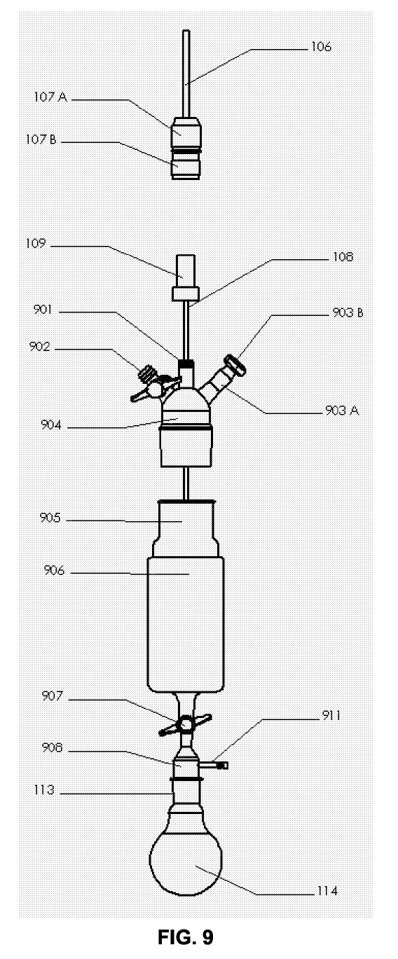

FIGS. 8 and 9 describe the glass container for the PUF extraction (111) which is built of borosilicate glass and has a mouth (905), which is used to introduce the PUF into the extraction system, this mouth (905) is a ground glass conical female NS64/46, which has an upper part (904) that fits a ground glass conical male NS64/46, that allows the hermetic closure of the extraction container (111) to avoid solvent spills during the extraction. In the same way and to avoid overpressures produced by the solvent evaporated during the process of compression and decompression of the PUF, the upper part (904) is equipped with a Teflon valve 2NS14 (902) that can be open at will during the process, thus preventing this problem. To incorporate new solvent portions or to change the extraction solvent, the same upper part (904) is equipped with a ground glass conical female (903A), NS13/23, which has a ground glass conical male lid (903B), NS14/23, which permits to hermetically close the extraction container (111) anew, once such solvent has been introduced. The glass male mouth with exterior thread (901) allows joining the Teflon piece (109) that works as a guide for the rod of the compression blade (108) so it introduces and moves in the proper vertical form through the interior of the body (906) of the glass container for the PUF extraction (111). Once the PUF has been extracted, the extraction solvent must be removed from the extraction container, for that purpose it is disposed a Teflon valve 2NS14 (907) connected to a ground glass conical male (908), NS28/32, that allows to connect directly to the extraction container, a round bottom distillation flask (114) that has ground glass conical female mouth (113), NS29/32. By this way, when the Teflon valve (907) is opened, the liquid is poured directly to the distillation flask (114), without the need to transfer the liquid to another container, allowing that such distillation flask (114) could be used directly in a rotary evaporatorator (not shown) for the subsequent elimination of the solvent nearly to dryness. The distillation flasks usually used in this process have different volumes (100, 250 or 500 ml), depending on the volume of the final extraction, the only restriction is that all must have a mouth compatible with the measures of the ground glass conical male (908). The glass male (908) also has an open hose connector that allows to even up pressures during the elimination of the extraction solvent from the extraction container (111), making easier the fall of the liquid to the distillation flask (909). Additionally and to achieve a greater extraction of the final extraction solvent, for its analysis as well as for subsequently achieving a greater efficiency in the drying of the PUF, the open hose connector (911) can be connected to an oil-free vacuum pump and apply vacuum for some minutes.

FIG. 10 shows a transversal cut through the extraction container (111), where it can be seen how the Teflon fastener fixes by its upper part (107A) the piston (106) rod and by its lower part (107B) the rod of the compression blade (108). It can also be appreciated, the Teflon adapter (109) that works as a guide for the proper and vertical entrance of the Teflon compression blade (108) to the interior of the extraction container (111). This figure shows in addition, the position of the PUF (1001) and the compression blade (108), whose lower part has welded a flat compression surface (1002), with circular form, of 5 cm diameter and it is made of borosilicate glass. This blade (108) has a series of perforations which allow on one hand to compress the PUF (1001) and on the other hand to let the extraction solvent drain every time such PUF (1001) is compressed. In the interior of the body (906) of the glass container for the extraction of the PUF (111), is placed the extraction solvent, which must inundate the PUF completely, in such a way that the polyurethane foam of the PUF (1001) is completely soaked in the solvent of choice. Once the extraction has ended, the blade (108) will keep pressuring the PUF strongly, by means of the regulation of the movement of the piston, as it was described in FIG. 2, in such a way that it stays in this position during the required time for the maximum elimination of the extraction solvent, leaving the PUF (1001) without solvent residues.

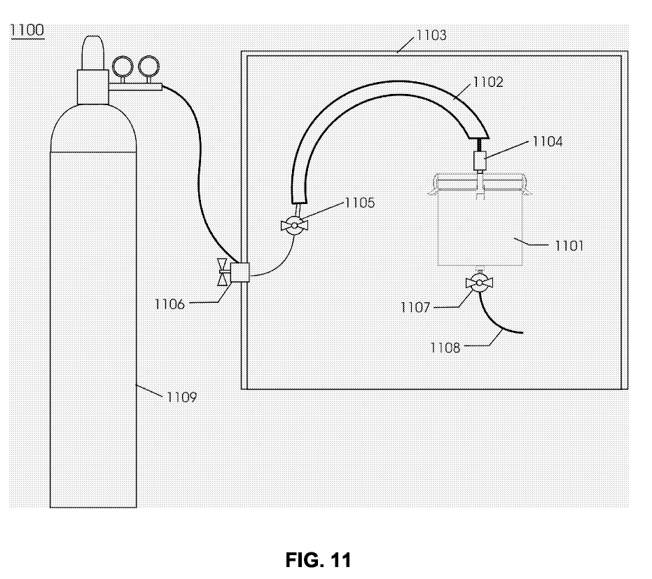

FIG. 11 shows the drying system for the PUF in a schematic form. For this purpose the drying container for the PUF (1101) must be connected to a hot nitrogen (N₂) line (1102) whose quality is ultra-pure grade. The gas supply comes from a N₂ cylinder (1109) that has a predetermined pressure, which is reduced by means of a secondary manometer to 4 bars (not shown). The N₂ pipe at 4 bars reaches an extraction hood (1103) and is connected to it by a needle valve for coarse flow regulation (1106), which is at the same time connected to a needle valve for fine flow regulation (1105). The hot nitrogen N₂ line (1102) is at the same time connected and regulated by the valve (1105), the thermal regulation of this line is accomplished thanks to a blanket provided with electric resistances regulated and controlled by a thermostat (not shown), which keeps the temperature of this line at approximately 70° C. The drying of the PUF (1001) is achieved by the process of N₂ sweeping of the residual solvent retained in the PUF, the heating of the N₂ helps to evaporate the solvent which significantly reduces the drying time. The N₂ that has passed through the PUF (1001) is discarded by a regulation valve (1107) through a tube (1108) to the interior of the extraction hood (1103).

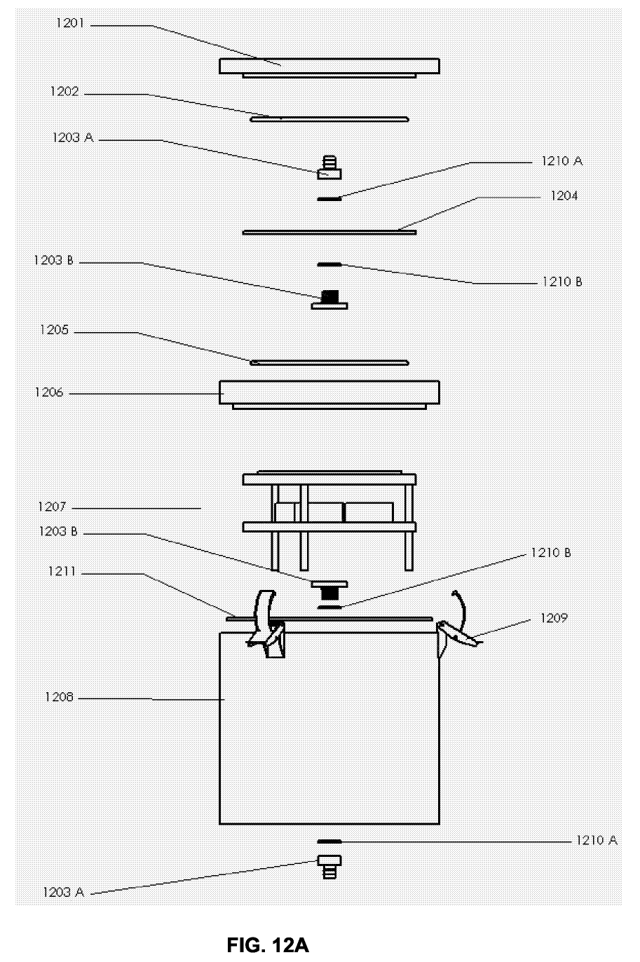

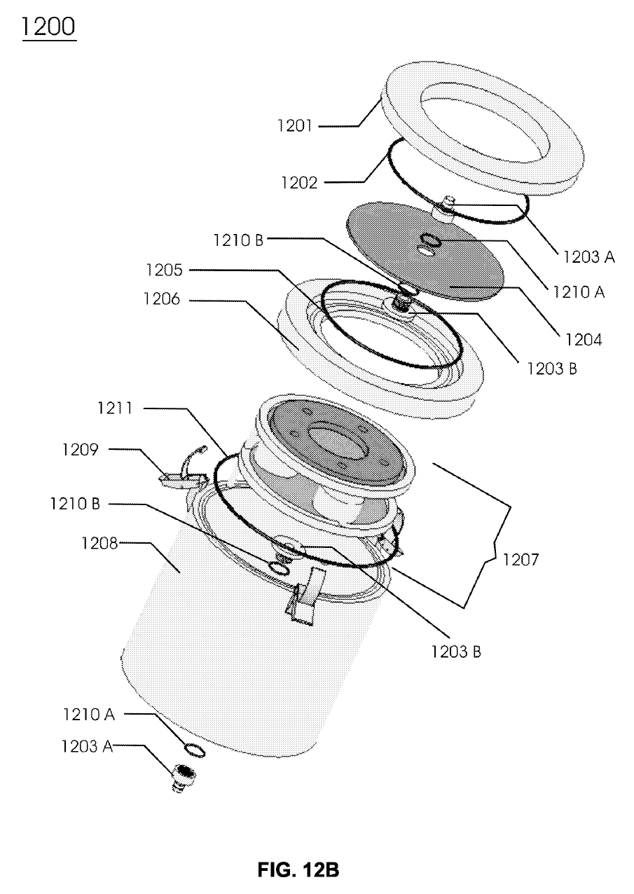

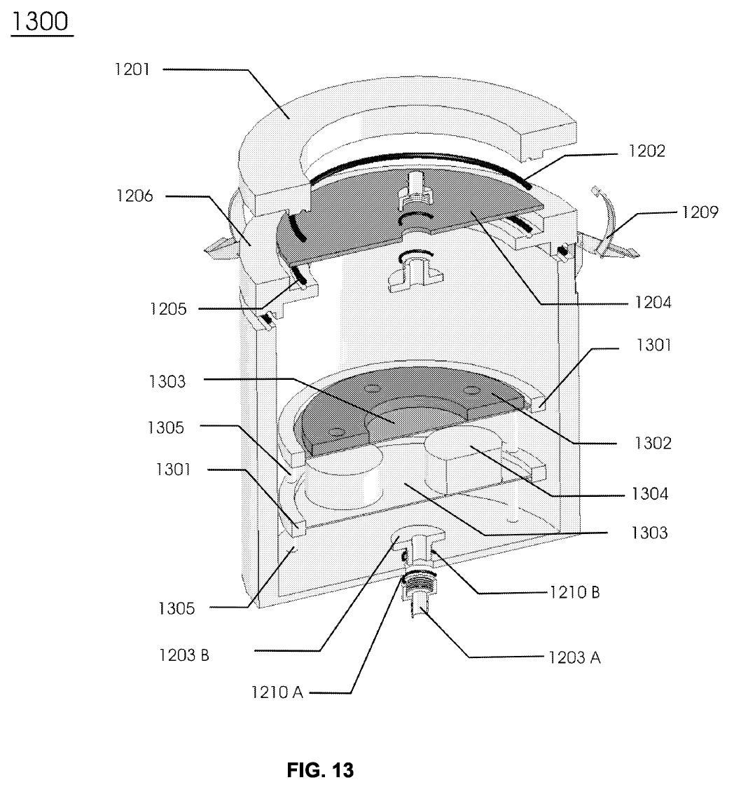

FIG. 12A shows the component parts of the drying container for the PUF (1101) in a schematic form. This drying container is composed of a lid, which has an upper part (1201) provided with a wedge for coupling with the lower part (1206) and a groove to accommodate a silicone o-ring (1202). This o-ring (1202) is suitable for hermetically pressuring a transparent 5 mm glass (1204) which stays tight inside the wedge of the lid between its upper part (1201) and lower part (1206) and works as a window to watch the drying process. The lower part (1206) also has a groove to accommodate a silicone o-ring (1205) similar in shape and function to the previous one. The glass window (1204) has in its center a metallic male (1203A) with interior and exterior sweglook thread to connect the hot N₂ line (1102) by a sweglook nut, this line allows the N₂ to enter in the drying container for the PUF (1101). This connection for N₂ entrance is hermetically closed against the glass (1204) by means of a security nut (1203B) which has an exterior thread that allows screwing it to a metallic male (1203A). Both pieces (1023A and 1203B) are moreover sealed against the glass by means of o-rings with appropriate diameters (1210A and 1210B). For the drying procedure, the PUFs are placed in a PUF support (1207) whose description is detailed in FIG. 13. This support is placed inside the lower part (1208) of the drying container of the PUF (1101), named body of the container. The lid and body of the container are joined by metallic fasteners (1209) which can be adjusted to achieve maximum tightness, as a form to obtain a hermetic closure of the drying container for the PUF (1101). In the lower part of the container (1208) there is a N₂ exit composed of a set of similar pieces to those previously described for the female and male parts 1203A and 1203B, both are once again sealed using identical o-rings of appropriate diameters (1210A and 1210B). In this way, the container (1208) is left hermetic and with the possibility of connecting by its lower part, in the rod of the security nut (1203B), a needle valve (not shown) which allows regulation of the N₂ exit flow to the exterior of the drying container of the PUF (1101).

FIG. 13 shows a transversal cut through the component parts of the drying container for the PUF (1101). In this figure it can be appreciated the upper and lower part of the lid of the drying container for the PUF (1101), which has an upper part (1201) provided with a wedge for coupling with the lower part (1206) and a groove to accommodate a silicone o-ring (1202). This o-ring (1202) is suitable for hermetically pressuring a transparent 5 mm glass (1204) which stays tight inside the wedge of the lid between its upper part (1201) and lower part (1206) and works as a window to watch the drying process. The lower part (1206) also has a groove to accommodate a silicone o-ring (1205) similar in shape and function to the previous one. FIG. 13 also shows details of the connection system for the drying container (1101) to the hot N₂, which is achieved with the use of a metallic male (1203A) and its respective security nut (1203B), and also with the hermetic adjustment to the glass window (1024) by means of silicone o-rings (1210A and 1210B) placed in the upper and lower part of the N₂ entrances (1203A and 1203B). The PUF support (1207), where the PUF are place for drying, consists of a first support (1301) to accommodate 15 cm diameter PUFs (1302) which is rested on a metallic grid with perforations of 1 cm (1302). The support (1301) rests on 2 cm cylindrical legs (1305) to separate it from the second support that has the same dimensions of the previous support (1301), for PUFs with 5 cm diameter (1304). This second support (1301) also rests on 2 cm cylindrical legs (1305) to separate it from the bottom of the drying container for the PUF (1208). The bottom of the container (1208) has a N₂ exit that has exactly the same set of pieces (1203A and 1203B) and o-rings (1210A and 1210B) previously described. In this way, the container (1208) is left hermetic and with the possibility of connecting by its lower part, in the rod of the security nut (1203B), a needle valve (not shown) which allows regulation of the N₂ exit flow to the exterior of the drying container for the PUF (1101).

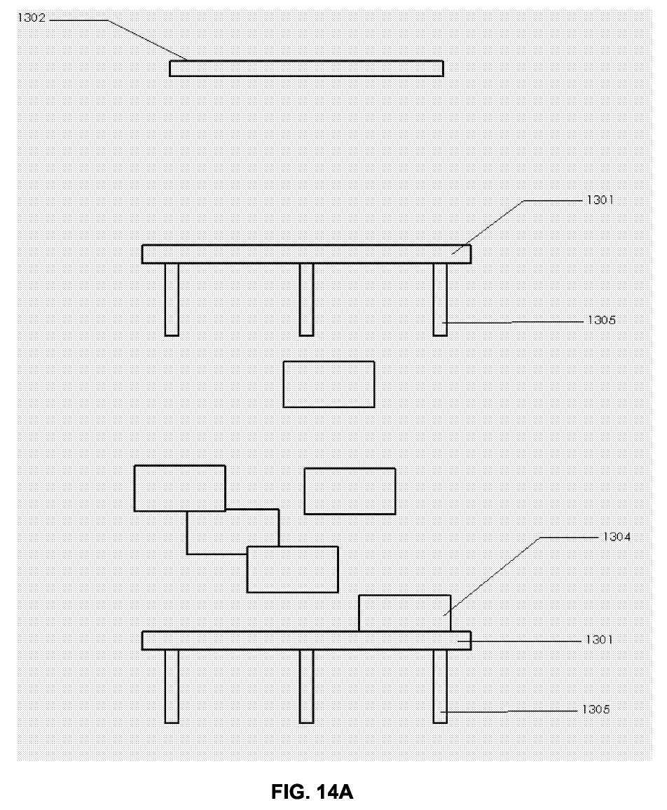

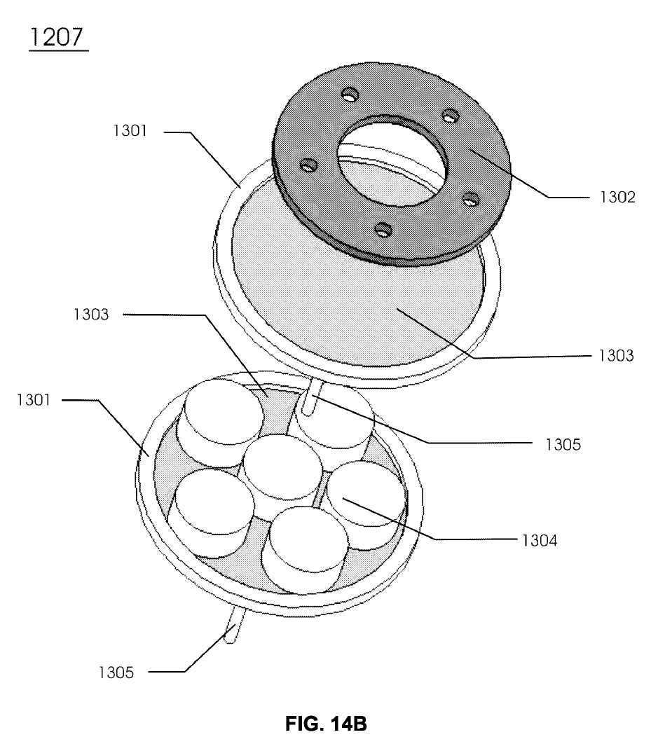

FIGS. 14A and 14B show the component parts of the PUF support (1207), which is the place where the PUFs are placed for the drying procedure, in the figure it can be appreciated the first support (1301) for 15 cm diameter PUFs (1303) and the second support for 5 cm diameter PUFs (1301). This second support (1301) allows accommodating up to 6 PUFs of 5 cm diameter (1304) each, permitting in this way to optimized the drying procedure, saving time and decreasing the amount of N₂, which results in a lower operational cost. Furthermore, on the second support (1301) can be placed an extra support (1301) with an appropriate diameter to accommodate 15 cm diameter PUF (1302), in this way the same procedure for drying the PUF (1304) can be used for drying the PUF (1302), and further optimize the use of the drying container for the PUF (1101).

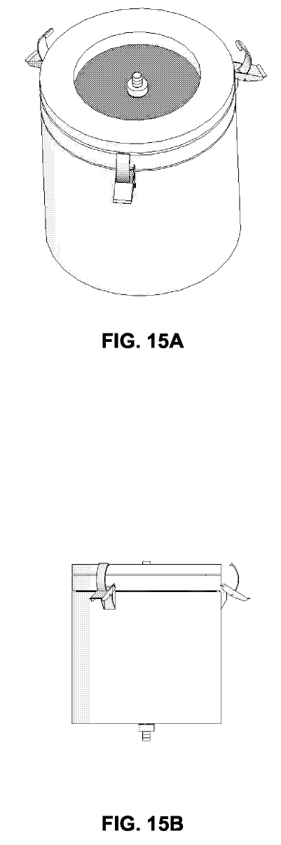

FIGS. 15A and 15B respectively show the drying container for the PUF (1101) in an isometric view and the same container (1101) closed. In this way it is used to dry the PUFs with 5 cm diameter (1301) and/or as well those with 15 cm diameter (1303).

The analytical procedures associated with this invention derive from the following activities:
A) PUF Cleaning: The automatic extraction equipment can be used for extraction of a PUF that is coming from an ambient air sampling or as well for cleaning a PUF that has residual contamination from its fabrication process before using it in a field sampling, as a form to reassure the cleanliness of the PUF at the time of taking an atmospheric sample. The result of this procedure is certified by a chromatographic analysis.
B) PUF Drying: Other secondary problem is to dry a PUF that has already been subjected to an extraction with solvents to assure its cleanliness. This apparently obvious procedure requires an automatic drying system for the PUF with the use of hot ultra pure nitrogen. The relevance of this drying procedure resides in the problem that if some minimum remains of solvent are left in the PUF, this stays very active and can be easily contaminated before reaching the sampling place, ruining the sample. In this way, the drying procedure guarantees a clean and dry PUF ready to be used for field sampling, without the problems previously mentioned.
C) PUF Storing: Once the PUF has been cleaned and dried, it is necessary to store it in such a form that it is not contaminated before reaching the sampling site.

### PUF Cleaning Procedure:

The PUFs are commercialized with a great number of contaminants that are inherent to their fabrication process. This contamination is so important that the PUF in this condition (dirty) is not suitable to be used as an adsorbent filter in the sampling of atmospheric aerosols, in particular to retain organic chemical compounds in gaseous state present in this type of samples. In this way, before using the PUF for this purpose, it must be decontaminated, put differently it must be cleaned and its cleanliness must be certified by chromatographic techniques that assure no residual substances are left that could prevent a good interpretation of the chromatograms of the real samples once these have been extracted to identify and quantify the analytes of interest. The developed invention precisely consists in an automatic system for PUF (100) extraction, which can be used either for the cleaning procedure as well as the extraction of the PUF. For the cleaning procedure of the PUF, previous to its use under monitoring conditions, it is used a sequence of extraction solvents, for 4 steps of 15 minutes each. Each step is composed of 3 cycles of compression and decompression of the PUF lasting 5 minutes each; starting the cleaning in the first step using 80 ml of water with Mili-Q quality, and then, in the second step using 80 ml of acetone, in the third step using 80 ml of toluene, and finishing the last period with 80 ml of n-hexane.

The extraction procedure starts with the addition of 80 ml of the first solvent that is the most polar one: water (Mili-Q quality) directly in the glass container for PUF extraction (111). After this, the PUF is picked with tweezers and carefully placed in the interior of the same container (111). Then, the upper part (904) of the extraction container (111) is held and introduced through the mouth of the glass male (901) that has attached to it the Teflon piece (109) that works as a guide for the rod of the compression blade (108) so this can be introduced and moved in a proper and vertical form in the interior of the body (906) of the glass container for PUF extraction (111) which fits a ground glass conical male NS64/46, that allows hermetically closing the container.

The extraction adjustment depends on the type of cleaning to be performed, where cycles of compression and decompression of the PUF submerged in the different solvents permit to extract from this solid support (PUF) the impurities previously described. Once the extraction process has ended, the extracted solution is poured in a distillation flask and the solvent is reduced by evaporation in a rotary evaporatorator 30° C. of temperature and under vacuum, until a final volume of 1-2 ml. The extract obtained in this step is poured in a 5 ml conical vial in a quantitative form and the excess volume is reduced again, this time under a nitrogen current until nearly dryness. Afterwards, it is dissolved again in 50 μl of solvent and 1 μl of this solution is injected in capillary gas chromatography equipment (GC), using an appropriate chromatography detector, according to the contaminants (FID, ECD, MS) nature, to verify if the cleaning procedure has been carried out successfully. The judgment to determine if this objective has been achieved is resolved by analyzing the size (area under the curve) of the chromatographic peaks obtained from the extract injected in the GC. The area previously mentioned must be inferior to the threshold defined as the maximum allowed accomplishing the PUF cleanliness. This chromatographic analysis permits to certify each PUF by separate and guarantee its use under field conditions in an atmospheric sampling; furthermore it can be used later for the quantification of the analytes of interest adsorbed in the PUF, after the monitoring has been performed.

### PUF Extraction Procedure:

The process involved in this invention is a procedure for extraction of ambient air samples, where organic chemical contaminants present in the MP as well as a gaseous phase are considered, grouped under the category of semivolatile organic compounds (SVOCs). In the particular case of the equipment developed in this invention, the objective is to extract from a filter named PUF, where the gaseous phase of the aerosol sample is retained, compounds with toxic properties such as Polycyclic Aromatic Hydrocarbons (PAHs) and Polychlorinated Biphenyls (PCBs) and also other families of SVOCs. Once the sampling cartridge has arrived to the laboratory, the PUF is taken out of the PUF compartment with the use of tweezers and carefully placed in the extraction container for the PUF (111), to which previously had been added the first extraction solvents and a internal standard solution to control losses in this procedure and as a manner to be able to calculate the exact concentration of analytes of interest. For this purpose, the PUF is subjected to an extraction with organic solvents of different polarity, where compression and decompression cycles of the PUF submerged in the different solvents allow extracting the analytes of interest from this solid support (PUF), during 4 periods of 15 minutes each. Each step is composed of 3 compression and decompression cycles of the PUF lasting 5 minutes each; initiate the extraction using 80 ml of Toluene in the first three steps, and end the extraction using 80 ml of n-hexane in the last step. After each cycle, the solvent is poured from the extraction container for the PUF (111), by means of opening the Teflon valve joined to a conical ground glass male, which permits to connect a distillation round bottom flask directly to the extraction container, in this way when the Teflon valve is opened, the solvent is poured directly to a distillation flask that has a mouth compatible with the dimensions of the conical ground glass male, this glass male also has an open hose connector, which permits to even up pressures during removal of the extraction solvent from the extraction container, making easier the flow of the liquid to the distillation flask. At the end of the extraction, 320 ml of solvents will be accumulated in the distillation flask containing the analytes extracted from the PUF. The volume of the solvent contained in the distillation flask is reduced by evaporation in a rotary evaporatorator at 30° C. of temperature and under vacuum, until reaching a final volume of 1-2 ml. The extract obtained in this step is poured to a conical vial of 5 ml in a quantitative manner and the excess volume is reduced again, this time under nitrogen current until nearly dryness. Subsequently, it is dissolved once more in 100 μl of solvent and subjected to a purification process using packed column chromatography, with the purpose of eliminating unwanted compounds and selecting only those families of interest organic compounds. Once the fractions of interest have been obtained, the excess volume is reduced again under nitrogen current until nearly dryness. Afterwards, the extract is dissolved once more with 30-50 μl of solvent according to the concentration level and 1 μl of the extract is injected in the capillary gas chromatography equipment, using an appropriate chromatography detector, according to the nature of the contaminants (FID, ECD, MS) to carry out the identification and quantification of the analytes of interest.

### PUF Storing:

As soon as a clean and dry PUF has been obtained, it is necessary to store it in such a way that it is not contaminated before reaching the sampling location. For this purpose, it is necessary to store the PUF wrapped in aluminium foil previously conditioned. The cleaning treatment for the aluminium foil consists in washing both faces of the material with acetone and drying it in a hood under absolute cleanliness conditions. Once the PUF has been wrapped in clean aluminium foil, it must be stored in a glass container with a hermetic lid. For greater security, the glass container is also wrapped in aluminium foil and stored in darkness. Only in this manner it can be assured a safe, and free of contamination storing of the PUFs before its final use in an atmospheric monitoring.

I claim:

1: A system for automatic extraction of gaseous atmospheric contaminants with toxic properties, such as Polycyclic Aromatic Hydrocarbons (PAHs) and Polychlorinated Biphenyls (PCBs), among others, which that are retained in polyurethane foam filters (PUF) which comprises comprising:
1. An automatic extraction device, where the automatic extraction device extracts gaseous atmospheric contaminants with toxic properties from the PUF which permits chemical compounds extraction from the PUF or cleaning the PUF before using under field sampling, where the automatic extraction device comprises a sequence of organic solvents, where the PUF must be is immersed in the sequence of organic solvents and subject to cycles of compression and decompression to extract gaseous atmospheric contaminants with toxic properties from the PUF, whereby means of extraction or cleaning process based in compression and decompression cycles of the PUF; and
2. A drying device, where the drying device to dry's the PUF by means of solvent sweeping with hot gaseous ultra pure N₂, thereby eliminating the solvent to achieve a desired dryness of the PUF.

2: The system for automatic extraction according to claim 1, wherein the automatic extraction device further comprises:
A mechanical-pneumatic piston, where the piston comprises a piston rod;
A control unit for solenoid valves, where the control unit controls the movement of the piston;
A metallic support; and
A glass container for PUF extraction fastened to such the metallic support.

3: The system for automatic extraction according to claim 2, where the automatic extract device further comprises an oil-free pressure pump with a fluorine containing polymer membrane, wherein the mechanical-pneumatic piston carries out the procedure of compression and decompression, whereby this is accomplished by compression of ambient air using the oil-free pressure pump with a fluorine containing polymer membrane where the oil-free pressure pump with a flouring containing polymer sends compressed air through tubes to a rapid connection of an entrance valve in the piston;
where lubrication of the piston is achieved by means of a minuscule layer of oil formed on the piston rod, where the layer of oil is supplied by an oil deposit that allows the formation of an air aerosol containing very small oil particles in suspension,
whereby to avoid any possible contamination from the oil of the system, there have been implemented two measures, the first one comprising a fluorine containing polymer fastener located at the inferior end of the piston rod that has a small sealed conicity in its superior piece, this conicity inevitably traps any possible drop that might fall from the oil layer from the piston rod and avoids the contamination of the inferior end of the fluorine containing polymer fastener;
where two parts form the fluorine containing polymer fastener, where these two parts are independent, consequently the contamination avoidance by this route is guaranteed;
where the second measure is an oil trap at the end of a tube that connects a rapid connection of an exit valve of the compressed air of the piston with the trap, where this washable and takedown trap is connected to an exit to definitively eliminate the residual compressed air from the system;
where the mechanical-pneumatic piston has a regulation screw at the entrance valve and at the exit valve of the piston, those screws can mechanically regulate the movement of the piston rod and in this manner enable the glass container for PUF extraction to fit different types, sizes, and densities of PUF, different extraction solvent volumes, and different extraction procedures;
where this regulation can also control the magnitude of pressure applied to the PUF during the compression and expansion steps as a means of improving the efficiency of extraction;
where the mechanical-pneumatic piston uses compressed air to work, where an exit tube transports pressurized air to the piston entering through a valve, where the return air exits through the valve and is leaded by a tube to entrance of the control unit;
where, to lubricate the piston, a device mixes air compressed by the oil-free pressure pump with a fluorine containing polymer membrane, where, with a small amount of oil, the air thus prepared is transported to a solenoid valve, where the solenoid valve is connected to an exit tube directed to the piston, where the residual air is discarded once it has passed through the piston, where the residual air exits the control unit through a tube and reaches the oil trap;
where, to avoid contamination inside the laboratory, this residual air is discarded through the tube.

4: The system for automatic extraction according to claim 2, wherein the control unit controls a plurality of solenoid valves that perform the movement of the piston by means of a PLC, where the PLC is a digital microprocessor that comprises an LCD screen and allows programming of different PUF extraction procedures by means of increasing the compression, based in a higher or lower pressure of the piston controlling the amount of air that is compressed, where the control unit comprises a series of electronic elements that indicate the ending of an operation sequence and thus permit determination of the time intervals for pressure versus pauses, and the total extraction time; where the control unit allows using PUFs with different thickness and/or densities; where the control unit allows to additionally compress the PUF to leave it as free as possible of extraction solvents.

5: The system for automatic extraction according to claim 2, wherein the metallic support comprises a cylindrical duraluminium support screwed to an iron base inserted in a plastic platform that permits the attachment of the mechanical-pneumatic piston to a cylindrical fastener of the extraction system;
where the cylinder has a fastener screw in its upper part that allows regulating the height at which a fastener support of the mechanical-pneumatic piston will finally be placed;
where the mechanical-pneumatic piston is screwed and secured to the cylindrical support on a small sheet metal, where regulation screws allow controlling the movement of the piston rod;
where plastic circular clamps support the glass container for PUF extraction, from its upper and lower part as well, where the plastic circular clamps have two parts, one that surrounds the cylinder, with a winged thread bolt for fastening and security and a second part that surrounds the glass container for PUF extraction.

6: The system for automatic extraction according to claim 2, further comprising an extraction container, wherein the glass container for PUF extraction is built of borosilicate glass and has a mouth that permits the insertion of the PUF in the extraction system;
where this mouth is a ground glass conical female which fits an upper part comprising of a ground glass conical male that allows a hermetic closure of the extraction container to avoid solvent spills during the extraction as well as to avoid overpressures produced by the evaporated solvent during the process of compression and expansion of the PUF, where the upper part is provided with a fluorine containing polymer valve that can be opened at will during the process;
where the same upper part is provided with a ground conical female, which has a ground conical male glass lid that allows a hermetic closure of the extraction container anew, once such solvent has been introduced;
where the system for automatic extraction further comprises a glass male mouth with exterior thread that permits it to join a fluorine containing polymer piece that works as guide for a rod of a compression blade so it can be inserted and moved in the right and vertical form inside the glass container body for PUF extraction;
where the system for automatic extraction further comprises a fluorine containing polymer valve joined to a ground glass conical male, whereby this allows the connecting of a distillation round bottom flask directly to the extraction container, thus when the fluorine containing polymer valve is opened, liquid is poured directly into a distillation flask that has a mouth compatible with the ground conical glass male, where this ground conical glass male has an open hose connector that permits the evening of pressures during the extraction of solvent from the extraction container, thereby facilitating the flow of liquid to the distillation flask.

7: The system for automatic extraction according to claim 1, wherein the drying device comprises:
a drying container for the PUF; and
a line for hot ultra pure nitrogen (N2) supply.

8: The system for automatic extraction according to claim 7, wherein the drying device for the PUF comprises a lid, where the lid has an upper part and a lower part, where the upper part comprises a wedge for coupling with the lower part, and where the upper part further comprises a a groove to accommodate a silicone o-ring;
where the silicone o-ring is used to hold tight and hermetic a transparent glass that is adjusted in the wedge between the upper and lower part of the lid, where the transparent glass is a window to observe the drying process;
where the lower part also comprises a groove to accommodate an additional silicone o-ring, where the additional silicone o-ring is similar to the silicone o-ring in form and function;
where the glass window has on its center a metallic male with an interior and exterior sweglook thread for connection to the hot ultra pure nitrogen line by means of a sweglook nut, where this connection allows the entrance of nitrogen to the drying container for the PUF;
where this nitrogen entrance connection is hermetically sealed against the glass by means of a lock nut that has an exterior thread which allows screwing it to the metallic male, where both pieces are sealed against the glass by means of the utilization of o-rings with appropriate diameters;
where the PUFs are placed on a PUF support located inside the lower part of the drying container for the PUF, or body of the container, for drying;
where the lid and the body of the container are coupled by means of metallic fasteners, where the metallic fasteners can be adjusted to achieve maximum tightness thereby obtaining a hermetic seal of the drying container for the PUF.

9: The system for automatic extraction according to claim 7, wherein the line of hot ultra_pure nitrogen (N₂) supply comprises a nitrogen cylinder filled with nitrogen at a predetermined pressure, where the predetermined pressure is reduced using a secondary manometer at 400 kPa (4 bars),
where a pipe with nitrogen at 400 kPa (4 bars) reaches an extraction hood, where the pipe with nitrogen connects to the extraction hood by means of a needle valve for coarse flow regulation, where the pipe with nitrogen is at the same time connected to a needle valve for fine flow regulation;
where the line for hot nitrogen supply is at the same time connected and regulated by the needle valve, where the thermal regulation of this line is achieved by use of a blanket provided with electric resistances which are regulated and controlled by a thermostat thereby keeping the temperature of this line at approximately 70° C.;
whereby the PUF drying is accomplished by means of the removal of residual solvent retained in the PUF using a process of sweeping with nitrogen, where the heating of the nitrogen helps evaporate the solvent and in this manner notably reduces the drying time, and where the nitrogen that has passed through the PUF is eliminated by a regulation valve through a tube to the interior of the extraction hood.

10: The system for automatic extraction according to claim 8, wherein the PUF support comprises a and a second support, where the first support for the PUF of a first diameter which rests on a metallic grid with perforations of 1 cm, where the first support is supported by cylindrical legs that separate it from the second support, where the second support has the same dimensions of the first support, but it is used for the PUFs with a second diameter, where the second diameter is smaller than the first diameter, where this second support is also rested on cylindrical legs to separate it from the bottom of the drying container of the PUF thereby allowing the free circulation of nitrogen.

11. An automatic method of extraction of gaseous atmospheric contaminants with toxic properties that are retained in polyurethane foam filters (PUF), wherein the method comprises the following steps:
extracting gaseous atmospheric contaminants with toxic properties from the PUF using a sequence of organic solvents where the PUF must be immersed, where the extraction is achieved by compression and decompression cycles of the PUF;
drying the PUFs by means of solvent sweeping with hot gaseous ultrapure nitrogen, where this step is continued until the PUF is dry; and
chromatographically certifying the cleanliness of the PUF.

12: The automatic method of extraction according to claim 11, wherein the step of extracting the gaseous atmospheric contaminants with toxic properties, the compression and decompression is achieved by means of a mechanical-pneumatic piston, a control unit for solenoid valves that controls the movement of the mechanical-pneumatic piston, a metallic support and a glass container for PUF extraction fastened to such support.

13. (canceled)

14. (canceled)

15. (canceled)

16. (canceled)

17: The automatic method of extraction according to claim 11, wherein the step of drying the cleaned PUF by means of solvent sweeping with gaseous hot ultra pure nitrogen, is performed in a drying container made of stainless steel, where the hot gaseous ultra pure nitrogen is supplied by a line of hot ultra pure nitrogen.

18. (canceled)

19. (canceled)

20. (canceled)

21: The automatic method of extraction according to claim 11, wherein it further comprises the step of storing the cleaned and dried PUF to avoid its contamination before reaching a sampling location.

22. (canceled)

23: The automatic method of extraction according to claim 11, wherein the sequence of organic solvents used to extract the gaseous atmospheric contaminants with toxic properties from the PUF uses organic solvents with different polarities, and where the sequence of organic solvents is performed during 4 steps of 15 minutes each, wherein each step is composed of 3 cycles of compression and decompression of the PUF lasting 5 minutes each, and where the sequence of organic solvents uses 80 ml of toluene during the first three steps, and where the sequence of organic solvents uses 80 ml of n-hexane during the last step.

24: The automatic method of extraction according to claim 11, wherein the sequence of organic solvents used to extract the gaseous atmospheric contaminants with toxic properties is initiated using a sequence of extraction solvents, where the sequence of organic solvents comprises 4 steps lasting 15 minutes each, wherein each step comprises 3 cycles of compression and decompression of the PUF lasting 5 minutes each, where the first step uses 80 ml of water with Mili-Q quality, where the second step uses 80 ml of acetone, where the third step uses 80 ml of toluene, and where the last step uses 80 ml of n-hexane.

25. (canceled)

26: The system for automatic extraction according to claim 1, wherein the gaseous atmospheric contaminants with toxic properties are polycyclic aromatic hydrocarbons.

27: The system for automatic extraction according to claim 1, wherein the gaseous atmospheric contaminants with toxic properties are polychlorinated biphenyls.

28: The automatic method of extraction according to claim 11, wherein the gaseous atmospheric contaminants with toxic properties are polycyclic aromatic hydrocarbons.

29: The automatic method of extraction according to claim 11, wherein the gaseous atmospheric contaminants with toxic properties are polychlorinated biphenyls.
